(19) United States
(12) Patent Application Publication
(10) Pub. No.: US 2006/0030049 A1
(43) Pub. Date: Feb. 9, 2006

(54) Apparatus for diagnostic testing and method

(75) Inventors: Alan Bhimani, Birmingham (GB); John Hunter, Rogers, MN (US); David Rathbone, Warwickshire (GB)

Correspondence Address: PYLE & PIONTEK, 221 N. LASELLE STREET, SUITE 850, CHICAGO, IL, 60601, US

(73) Assignee: IMI Vision Limited

(21) Appl. No.: 11/194,856

(22) Filed: Aug. 1, 2005

(30) Foreign Application Priority Data
Aug. 4, 2004 (GB) GB 0417395.1
Oct. 8, 2004 (GB) GB 0422326.9

(51) Int. Cl. G01N 35/00

(52) U.S. Cl. 436/43; 422/100; 436/180

(57) ABSTRACT

Controlled dispense of a flowable reagent in a diagnostic system is characterized by placing in the diagnostic system at least one cartridge containing a reservoir of reagent and carrying an identifier device that has information pertinent to the reagent in the reservoir. The diagnostic system automatically reads the information contained in the identifier device and uses the information to control the diagnostic system in dispensing the reagent. The information contained in the identifier device may consist of one or more of an identification of the reagent in the reservoir; the expiration date of the reagent the active shelf life of the reagent; the volume of the reagent in the reservoir; an identification of the origin of the reagent; and the maximum storage temperature of the reagent.

### FIELD OF THE INVENTION

The present invention relates to dispensing of a flowable reagent in a diagnostic system.

### BACKGROUND OF THE INVENTION

Diagnostic testing systems, such for example as in vitro diagnostic systems, are known and commonly comprise, in the case of in vitro diagnostic systems, the stages of placing a sample of a body fluid or component thereof in a vessel, adding a quantity of one or more reagents, allowing the sample and reagent(s) a certain incubation time and using any one of a number of methods known in the art to analyze the sample after the incubation period. One such diagnostic testing system is disclosed in U.S. Pat. No. 4,844,868, the teachings of which are incorporated herein by reference.

Various reagents are used in the process and may include, for example, enzymes and proteins. Some reagents are fairly long lived, whereas others have a limited shelf life. Further, if the wrong reagents are used, for example by human error when loading the reagents into the diagnostics system, then the results of the test will be faulty. This clearly is not acceptable in the medical field. Another problem associated with some reagents, particularly some enzymes, is that they are temperature sensitive and can deteriorate if not stored in the correct temperature conditions.

### OBJECTS OF THE INVENTION

An object of the present invention to provide a method of safety and accurately using reagents in diagnostic systems.

Another object is to provide such a method in which a cartridge containing a reagent, for use in an in vitro diagnostic system, includes means for identifying pertinent information about the reagent to the diagnostic system, which information is used by the system to determining the efficacy of the reagent to provide accurate test results.

### SUMMARY OF THE INVENTION

In accordance with the present invention, a method of controlling dispensing of a flowable reagent in an in vitro diagnostic system comprises the steps of placing in the diagnostic system a cartridge having a reservoir of reagent, a temperature sensor for sensing the temperature of the reagent and an identifier that contains information pertinent to the reagent, including the sensed temperature of the reagent; reading with the diagnostic system the information contained in the identifier; and using the information read by the diagnostic system to control the diagnostic system in dispensing reagent from the cartridge.

The cartridge may have a disposable sanitary pump for dispensing reagent from the reservoir, and included are the steps of driving the pump with the diagnostic system to dispense reagent; and controlling the diagnostic system in performing the driving step in accordance with information contained in the identifier. The information contained in the identifier may consist of one or more of: an identification of the reagent in the reservoir; the expiration date of the reagent; the active shelf life of the reagent; the volume of the reagent in the reservoir; an identification of the origin of the reagent; and the maximum storage temperature of the reagent, above which the quality of the reagent can deteriorate.

The diagnostic system can utilize more than one cartridge at a time, in which case the placing step comprises placing a plurality of cartridges in the diagnostic system, the identifier of each cartridge containing information relating to the identity of the reagent in the reservoir of the cartridge. The reading step then comprises reading with the diagnostic system the identity of the reagent in the reservoir of each cartridge, and the using step comprises using the identity of the reagent in the reservoir of each cartridge to control the diagnostic system in dispensing reagent from a selected one or more of the cartridges.

Where the cartridge identifier contains information concerning the expiration date of the reagent in the reservoir, the using step includes the step of preventing the diagnostic system from dispensing reagent that has expired. Where the cartridge identifier contains information concerning the active shelf life of the reagent in the reservoir, the using step includes the step of preventing the diagnostic system from dispensing the reagent if its active shelf life has expired or, alternatively, generating a signal to indicate expiration of the active shelf life of the reagent

The identifier may be permanently associated with the cartridge and include a radio frequency identification (RFID) tag, in which case the reading step includes reading the RFID tag with a reader of the diagnostic system. Where a plurality of cartridges are placed in the diagnostic system, the reading step comprises providing the diagnostic system with an RFID tag reader at each position where a cartridge is placed for reading only the information contained in the identifier of the cartridge placed in that position. Advantageously, each RFID reader includes a short range reader circuit that has a limited operating range, so that the RFID reader cannot read the information contained in the RFID tag of a cartridge until the cartridge is substantially inserted into the diagnostic system and so that it cannot read information contained on other nearby cartridges. The short range reader circuits may have a single operating frequency that can be above 13 MHz.

Preferably, the reading step includes providing the diagnostic system with an identifier reader/writer, so that the diagnostic system can read information from the cartridge identifier, write information to the identifier and overwrite information on the identifier. The cartridge identifier may be a universal data tag comprising at least one of memory circuitry and processor circuitry, and the tag is attached to the cartridge and advantageously conforms to a predetermined physical size independent of its functionality. The universal data tag may consists of a printed circuit board on which the at least one of memory circuitry and processor circuitry is provided, and included is the step of providing the printed circuit board with a transceiver for communicating with the diagnostic system reader/writer. The printed circuit board may be provided with a printed 1000 μH inductor for inductive non-contact or wireless communication between the at least one of memory circuitry and processor circuitry and the diagnostic system reader/writer, thereby enabling use of radio frequency identification (RFID) type devices ranging from 125 kHz to 13.56 kHz operating frequency. Further, the printed circuit board can be a double sided board having the inductor mounted on one side and the at least one of memory circuitry and processor circuitry mounted on the other side.

The printed circuit board may be provided with a plurality of contact pads and the diagnostic system with physical spring contacts, with contact being established between the contact pads and spring contacts to enable the diagnostic system to read and write information from and to the cartridge universal data tag. The at least one of memory circuitry and processor circuitry may comprise an Electro-Erasable-Programmable-Read Only Memory (EEPROM) chip, which may be provided with four contacts comprising a ground contact, a positive voltage in contact and two signal contacts. Reading information from and programming information to the EEPROM can occur in a serial addressed manner, and a power supply may be provided for the EEPROM by charging an internal capacitor of the EEPROM from a positive voltage sing from data sent to the EEPROM by the diagnostic system.

The universal identification tag may be used in an active role by providing it with a central processor and a battery power source, in which case the step of providing a battery power source can provide the battery power source as a separate component located on the cartridge, with the circuit board then being provided with contacts to connect to the battery. The universal identification tag can be such as to store information in magnetic form, and it can store information on a read/write magnetic strip.

When the identifier contains information relating to the volume of reagent in the cartridge reservoir, the reading step can include reading with the diagnostic system the volume of reagent in the reservoir upon the cartridge being placed in the diagnostic system and then, as reagent is used, performing with the diagnostic system the additional steps of calculating the volume of reagent remaining in the cartridge reservoir, and writing to the cartridge identifier information relating to the volume of reagent remaining. The step of writing information to the cartridge identifier relating to the volume of reagent remaining in the cartridge reservoir may be performed every time reagent is used from the reservoir, and it may be performed prior to removal of the cartridge from the diagnostic system.

When the cartridge identifier includes information relating to the active shelf life of the reagent, the reading step can comprise reading with the diagnostic system the active shelf life of the reagent when the cartridge is first inserted into the diagnostic system. In this case, the diagnostic system may use the date of insertion of the cartridge into the diagnostic system to calculate the expiration date of the active shelf life of the reagent and write the active shelf life expiration date to the cartridge identifier. The diagnostic system may be inhibited from dispensing further reagent from a cartridge once the active shelf life expiration date of the reagent has passed, or it can signal the occurrence of expiration.

The steps of detecting and recording the temperature of the reagent may be performed by providing the cartridge with a dedicated circuit containing a thermal fuse associated with the identifier, by providing the cartridge with an electronic temperature monitor associated with the identifier, or by using a magnetic device that looses a portion of its magnetic coding while the temperature of the reagent remains changed past the at least one predetermined temperature. Advantageously included is the step of measuring the time for which the temperature of the reagent remains changed past the at least one predetermined temperature.

The invention also contemplates a cartridge for containing reagent for use in an in vitro diagnostic system. The cartridge comprises a reservoir for holding reagent; means for sensing the temperature of the reagent; means for dispensing reagent from the reservoir; and data means containing information pertinent to reagent contained in the reservoir, including the sensed temperature of the reagent.

The temperature sensing means senses the storage temperature of the reagent and provides the storage temperature to the data means, and the means for dispensing reagent from the cartridge includes a disposable sanitary pump. The data means advantageously contains information over and above the temperature of the reagent, and desirably also contains information pertinent to one or more of: an identification of the reagent in the reservoir; the expiration date of the reagent; the active shelf life of the reagent; the volume of reagent in the reservoir; the origin of the reagent; and the maximum storage temperature of the reagent. The data means may comprise a radio frequency identification (RFID) tag and can have information both read from and written to it. The data means may also comprise a printed circuit board having at least one of memory circuitry and processor circuitry, along with a transceiver for use in reading information from and writing information to the at least one of the memory circuitry and the processor circuitry.

To provide for communication with the data means the cartridge may include electrical contact means electrically coupled to the data means to accommodate reading data from and writing data to the data means, and the at least one of the memory circuitry and the processor circuitry can comprise an Electro-Erasable-Programmable-Read Only Memory (EEPROM) chip. The cartridge can further including a power supply for the EEPROM, comprising a capacitor charged by a positive voltage sing from data sent to the EEPROM. Alternatively, self-contained battery means can be provided to power the data means. The data means may be a read/write magnetic strip or a bar code.

The invention further comprises an in vitro diagnostic system that uses a flowable reagent in the performance of diagnostic testing. The system comprises a cartridge including a reservoir for holding reagent, means for dispensing reagent from the reservoir, means for sensing the temperature of reagent in the reservoir, and data means containing information pertinent to reagent in the reservoir, including the sensed temperature of the reagent; and an apparatus for receiving the cartridge and for using reagent in the cartridge reservoir to diagnostically test a fluid, the apparatus including reader means for reading information contained by the cartridge data means, means for operating the cartridge dispensing means to dispense reagent from the cartridge reservoir, and control circuit means for controlling the operating means to dispense reagent from the cartridge reservoir in accordance with information read by the reader means from the cartridge data means.

In a contemplated embodiment of the system, the cartridge dispensing means includes a disposable sanitary pump for dispensing reagent from the reservoir, and the apparatus operating means operates the pump under control of the control circuit means to dispense reagent in accordance with information read by the reader means from the cartridge data means. Information contained in the cartridge data means advantageously consists of one or more of: an identification of the reagent in the reservoir; the expiration date of the reagent; the active shelf life of the reagent; the volume of the reagent in the reservoir; an identification of the origin of the reagent; and the maximum storage temperature of the reagent. With such information available from the cartridge data means, in one of its operations the apparatus control circuit means prevents operation of the operating means to dispense reagent from the cartridge reservoir in response to the reader means reading from the cartridge data means an expiration date of the reagent that has passed. In another of its operations, the apparatus control circuit means prevents operation of the operating means to dispense reagent from the cartridge reservoir in response to the reader means reading from the cartridge data means an active shelf life of the reagent that has passed.

The cartridge data means can include a radio frequency identification (RFID) tag and the apparatus reader means reads information contained by the RFID tag. The cartridge data means desirably is a read/write data means and the apparatus reader means is a read/write means for both reading information from and writing information to the cartridge read/write data means.

The cartridge data means can also comprise at least one of memory circuitry and processor circuitry, and it can include a printed circuit board having the at least one of the memory circuitry and the processor circuitry, and can also include a transceiver, such that the apparatus reader means including read/write means for reading information from and writing information to the at least one of the memory circuitry and the processor circuitry via the transceiver. The at least one of the memory circuitry and the processor circuitry may comprise an Electro-Erasable-Programmable-Read Only Memory (EEPROM) chip, and the EEPROM chip can have a power supply that comprises a capacitor charged by a positive voltage sing from data sent to the EEPROM by the apparatus read/write means.

It also is contemplated that the cartridge data means include magnetic data storage means and that the magnetic data storage means comprise a read/write magnetic strip. In a further alternative, the cartridge data means can comprise a bar code, and the cartridge temperature sensing means may comprise one of a thermal fuse, an electronic temperature monitor and a magnetic temperature sensing means that loses a portion of its magnetic coding while the temperature of the reagent remains changed past at least one predetermined temperature.

The foregoing and other objects, advantages and features of the invention will become apparent upon a consideration of the following detailed description, when taken in conjunction with the accompanying drawings.

### BRIEF DESCRIPTION OF THE DRAWINGS

The invention will now be described, by way of example only, with reference to the following drawings in which:

FIG. 1 is a perspective view of a disposable reagent cartridge in accordance with the invention;

FIG. 2 is a perspective view of the underside of the disposable reagent cartridge showing the location of the identification means;

FIG. 3 is an exploded view of a cartridge with opposite halves of the cartridge spread apart and showing internal integral pumping means contained within the cartridge;

FIG. 4 is a fragmentary view a flexible container for containing the reagent within a cartridge of the invention;

FIG. 5 shows an identification means for association with a cartridge of the invention;

FIG. 6 is a pictorial representation of an apparatus embodying the teachings of the invention, and

FIG. 7 is a flow diagram of the control logic of the apparatus of FIG. 5.

### DETAILED DESCRIPTION

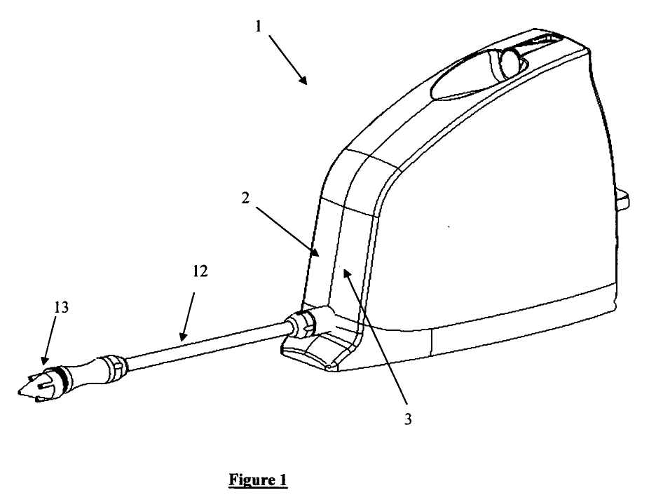

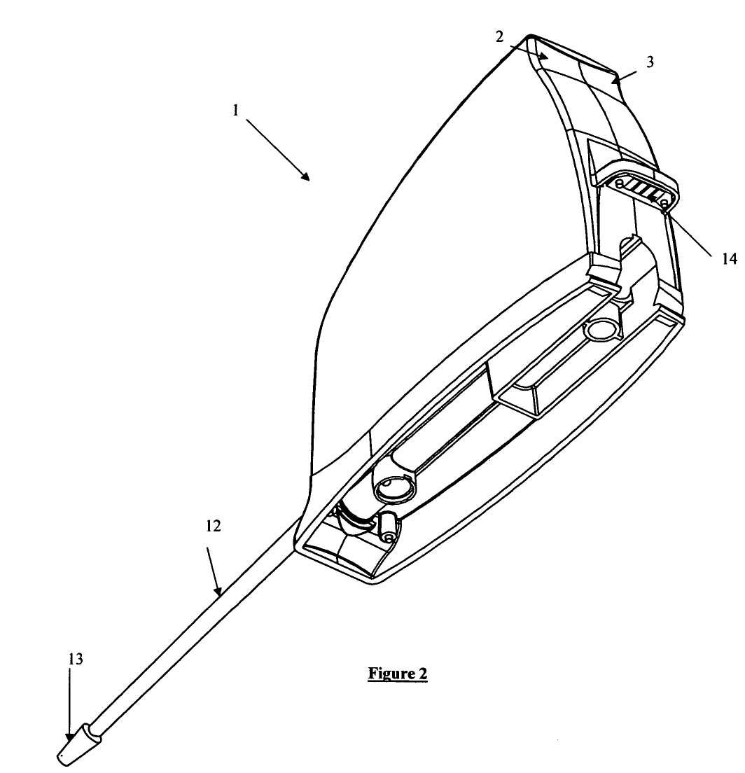

Automatic reagent distribution and analysis apparatus are well known, such as that shown in said U.S. Pat. No. 4,844,867, the teachings of which have been incorporated herein by reference. In improving upon such known apparatus and its method of operation, and referring to FIGS. 1-3, in accordance with the present invention a disposable reagent cartridge 1 is shown as comprising a moulded plastic two-piece shell 2 and 3 and a reagent reservoir 4 having a one way valve 5 leading into it for filling the reservoir with reagent through the valve. Two non-return or one-way valves 6 and 7 respectively lead into and out of a pump chamber 8, the size of the chamber being varied in volume by movement through the chamber of a pump piston 9 attached to a drive member 10 via a piston shaft 11. The drive member 10 is coupled to and moved by any suitable external drive (not shown), such as an external drive provided by an in vitro diagnostics system into which the cartridge 1 is placed, so that when the drive member 10 is driven in one direction (rightward as shown), the piston 9 moves rightward to draw reagent from the reservoir 4 and through the non-return valve 6 into the pump chamber 8, and when the drive member 10 is driven in the other direction (leftward as shown), the piston 9 pushes the reagent out of the pump chamber 8 and through the non-return valve 7 into and through a flexible tube 12 to and out of a tip valve 13.

The conduit 12 is flexible, so that the tip valve 13 may be positioned to dispense reagent to the required location. It will be appreciated, however, that the conduit 12 need not necessarily be flexible and that a rigid conduit could be employed or, alternatively, the tip valve 13 could extend directly from the cartridge 1. The cartridge carries an identification means that may comprise, by way of example, a read/write radio frequency identification (RFID) tag 14 attached to the cartridge, which identification tag contains coded information relating to the reagent contained within the reservoir 4, for example the reagent type, its concentration, its expiration date, etc. The cartridge 1 is for being placed into an in vitro diagnostic system to provide reagent for use in the system, and in that connection the system is provided with appropriate means to read the information contained on the RFID tag 14 and to use the information to operate the system in a manner to dispense a required volume of reagent from the cartridge at the given concentration in order to perform accurate diagnostic testing. An array of such cartridges 1 is normally provided for each diagnostic system, so that a single diagnostic system may dispense different volumes of different reagents from different cartridges to perform necessary diagnostic tests. By virtue of information pertaining to the reagent contained in each cartridge 1 being provided on the cartridge by an associated identifier device or identification tag 14, user errors resulting from placing a wrong reagent cartridge in a diagnostic system are eliminated. In use, the diagnostic system advantageously records how much of each reagent has been used and, optionally, writes this information back to the RFID tag of the cartridge 1 for the particular reagent, whereby the diagnostic system can automatically determine when a reagent cartridge is expired and discontinue dispensing it and/or signal for it to be replaced.

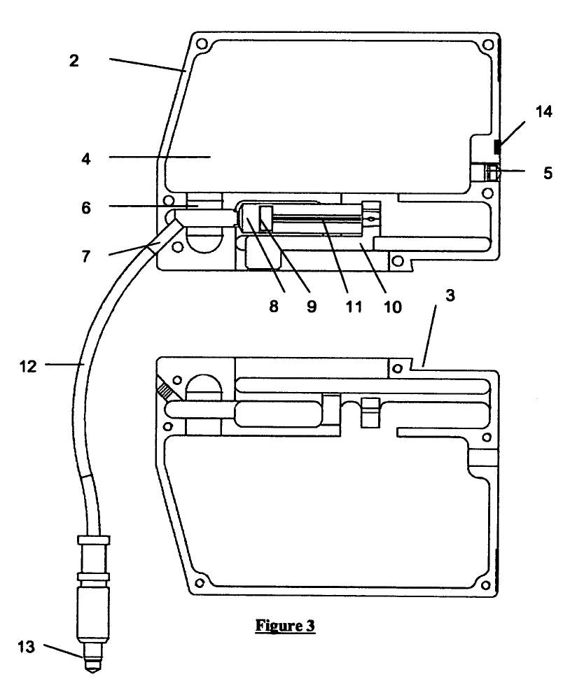

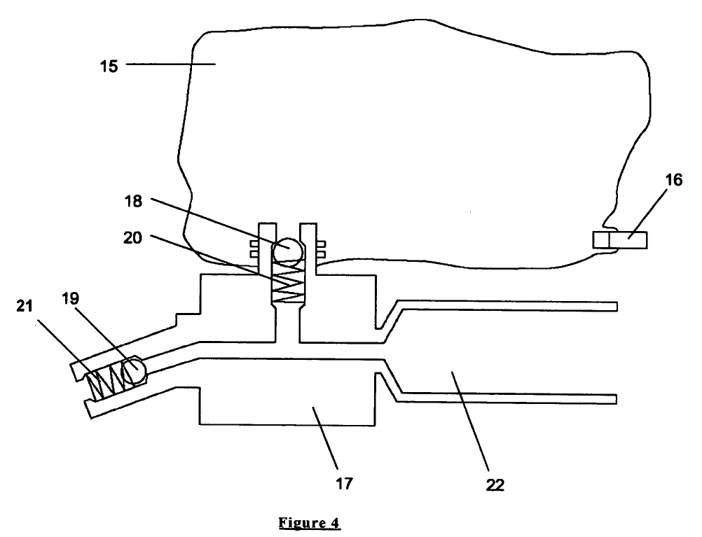

FIG. 4 shows a removable reagent container consisting of a flexible bag 15, which may be carried in a cartridge (not shown), having a small one-way valve 16 that accommodates filling of the bag with an ingredient or reagent. A plastic moulding 17 connects to an outlet from the bag 15 and includes a pair of non-return valves comprising ball elements 18 and 19 and associated springs 20 and 21. The moulding 17 forms an internal pump chamber 22 in which a piston (not shown) slides to draw reagent into the chamber through the one-way valve 18, 20 and to then expel the reagent from the chamber through the one-way valve 19, 21, in a manner similar to operation of the pump described in connection with FIG. 3.

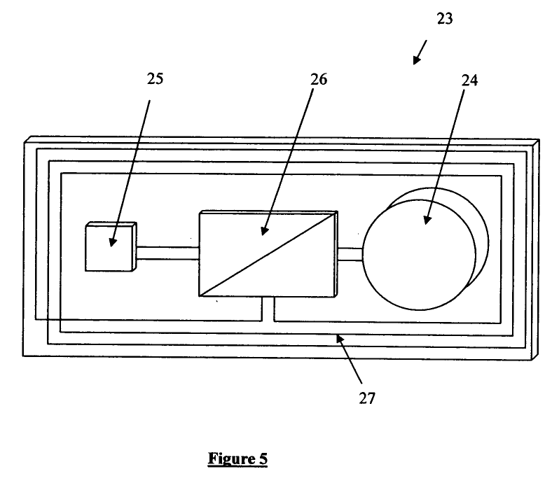

In FIG. 5 an example of an identification means suitable for use with the cartridge shown in FIGS. 1 to 4 is shown in the form of a small circuit board 23 which is attached to a cartridge (not shown). The identification means comprises four components: (1) a battery 24, preferably a low-drain 3V lithium battery, for example a ECR2032 lithium battery from Energizer, for supplying power to the identification means when the cartridge is in storage; (2) a temperature sensor 25, for example a SHT15 combined temperature and humidity sensor from Sensirion AG, for monitoring the temperature at which the cartridge, to which the identification means is attached, is stored; (3) a micro flash controller device 26, for example a PIC 16F639 with AFE (Analog Front-End) for 125 Khz RFID control, including a real time clock, for example a MAX6900, I²CT™-bus-compatible real-time clock (RTC) from Maxim Integrated Products; and (4) an aerial 27, for example a MLX90125-CZA-B Antenna Coil from Microelectronic Integrated Systems, to enable wireless communication with an in-vitro diagnostic system. If prior to or during use the temperature of a cartridge goes outside a specified range for longer than a specified time frame, then the micro flash controller can sense and save this information and, when the cartridge is attached to the diagnostic system, the system can read this from the cartridge and raise a warning and/or not dispense any of the reagent form that cartridge. This can result in the prevention of false negative or false positive tests from use of reagents which have deteriorated due to storage conditions.

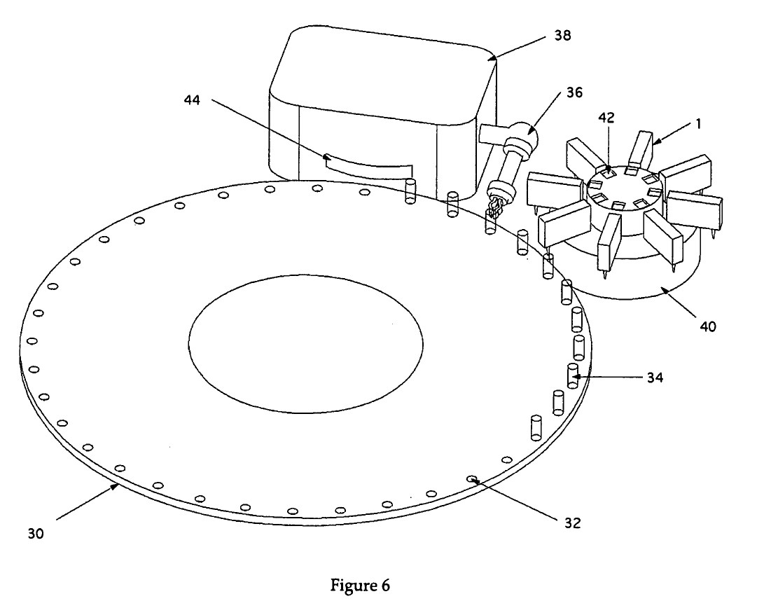

FIG. 6 shows one possible configuration of an in vitro diagnostic system into which one or more reagent contaning cartridges 1 may be placed in practice of the invention. The diagnostic system comprises a rotary table 30 having in an upper surface a circular array of openings 32 for receiving vials 34 containing fluid, such as blood plasma, that is to be diagnostically tested. The diagnostic system includes an arm 36 for placing vials 34 into the rotary table openings 32, although placement of the vials into the openings could, if desired, be accomplished manually. Control circuitry that may comprise a microprocessor or CPU (not shown) is situated in a housing 38 and is programmed to control operation of the diagnostic system and to perform diagnostic testing on the fluids in the vials 34. Alongside the rotatable table 30 is a rotatable carousel 40 that carries a number of reagent cartridges 1 of the type as described in connection with FIGS. 1-5. Toward the center of the carousel 40 is a circular array of readers 42, each associated with a position for a cartridge 1 on the carousel and each of which reads data contained on the identification means 14 of the cartridge 1 placed in the associated cartridge receiving position. The readers 42 communicate the data to the control circuitry in the housing 38 for verification at to whether each individual cartridge has been stored within specified storage parameters and whether the reagent contained the cartridge is within its shelf life when the cartridge is placed in the carousel 40. Communication between the readers 42 and CPU is bidirectional and the readers also have writing capability that is used to write to the identification means 14 of each cartridge the date the cartridge is first inserted into the diagnostic system. When a diagnostic test is to be performed, the control circuitry communicates with the carousel readers 42 to verify that all required reagents are loaded in the carousel 40 and are within their storage parameters and, if so, then controls the diagnostic system to position a selected one or more of the cartridges 1 relative to a vial 34 to dispense the required reagent(s) into the test sample in the vial. Once reagent has been dispensed into a vial 34, The CPU then controls the reader 42 associated with the cartridge 1 containing the dispensed reagent to write the remaining volume of reagent in the cartridge to the identification means 14 carried by the cartridge. The system includes sensor means 44 that examines the test fluid in a vial 34 after reagent has been added to the vial, and the control circuitry then uses data provided by the sensor means to output the results of the diagnostic test that has been performed.

In practice of the invention to dispense a flowable reagent in a diagnostic system, for example in a medical diagnostic system such as an in vitro diagnostic system, at least one cartridge containing a reservoir of reagent and having identification means containing information pertinent to the reagent is placed in the diagnostic system. The diagnostic system includes any suitable read/write electronic circuit or other suitable components for automatically reading the information contained in the identification means when the cartridge is placed in the system and for using the information to control the system to dispense reagent from the cartridge. The cartridge desirably contains means, such as the temperature sensor 25 and micro flash controller 26, for detecting if the temperature rises above or falls below one or more predetermined temperatures and for storing that information for later transmission to the diagnostic system. The cartridge also desirably includes a disposable sanitary pump that may be of a type described in respect of FIGS. 3 and 4, whereby the reagent it contains only contacts the disposable pump and the pump is not subsequently used to deliver other reagents, thereby avoiding contamination issues. The diagnostic system reads information on the identification means carried by the cartridge and uses the information in control of its operations, including controlling driving of the disposable pump to dispense reagent

Preferably, the information contained within the identification means carried by the cartridge comprises an identification of one or more, and preferably all, of: (1) the reagent within the cartridge; (2) the expiration date of the reagent; (3) the active shelf life of the reagent once the cartridge is placed in the diagnostic system; (4) the volume of reagent in the cartridge; (5) the origin of the reagent by batch number, date, and location; and (6) the maximum permissible storage temperature of the reagent. Automatic reading of this information by the diagnostic testing system reduces the potential for human error. For example, where the identification means carried by the cartridge includes the type or nature of the reagent contained by the cartridge, the diagnostic system is able to automatically determine whether the proper reagent has been loaded into it, whereby the potential for human error in loading the wrong reagent is eliminated.

When the identification means provides the expiration date of the reagent, upon automatically reading the expiration date the diagnostic system does not allow the reagent to be used in diagnostic testing if it is past its expiration date. This, again, eliminates the possibility of human error in using out of date reagents.

Since some reagents have a limited shelf life once opened or used, which may cause the reagent to expire prior to the expiration date that would apply if the reagent were unopened, the identification means advantageously contains information relating to the active shelf life of the reagent once it has been placed into the diagnostic system. The system can then automatically determine when the reagent is expired and generate a signal that it needs to be changed, whether or not there is still reagent remaining in the cartridge.

The information contained within the identification means may be permanently associated with the cartridge for being read by the diagnostic system and the identification means for each cartridge may be an RFID tag, in which case the diagnostic system contains a reader for reading the RFID tag.

The invention contemplates that a plurality of cartridges be placed in the diagnostic system and that in each cartridge receiving position the system have a reader that detects and reads information from the identification means on its associated cartridge, but only when the information means on the cartridge is in close proximity to the reader in order to prevent an overlap in readings, i.e., to prevent a reader from reading not only the identification means of its associated cartridge, but also the identification means of a nearby cartridge. Each reader for the diagnostic system may therefore be a short range reader circuit having an operating range limited to a few centimetres, so that each reader senses and reads information from only the identification means of its associated cartridge when its associated cartridge is inserted into the diagnostic system, and does not communicate with any other cartridge. Advantageously, the short range reader circuit operates at a single operating frequency that preferably is above 13 MHz, thereby enabling use of a low powered reader circuit.

Instead of the identification means specifically described, such as the RFID tag 14 and the circuit board 23, the identification means may comprise any other suitable device such as a bar code located on an outer surface of the cartridge or a magnetic memory.

The invention further contemplates that information be initially written to identification means permanently associated with a cartridge and that the diagnostic system include a reader/writer, so that the system can not only read information from the cartridge but can also write new information to, or overwrite existing information on, the cartridge. The identification means may be a “universal data tag” comprising memory and/or processor electronics, and since the identification means is attached to the cartridge, it preferably conforms to a predetermined physical size independent of its electronic and/or connective functionality, thereby enabling the memory and/or processor electronics embodied in the identification means to be selected from different technologies for different commercial or technical reasons, without the necessity to modify the cartridge case to which the identification means is attached. The identification means may consist of a printed circuit board, on which the memory and/or processor electronics are provided, with the printed circuit board being capable of encompassing a range of different methods for communicating with the reader/writer of the diagnostics system. For example, the printed circuit board may contain a printed 1000 μH inductor for inductive, non contact communication between the printed circuit board and the reader/writer of the diagnostics system, allowing for the use of RFID type devices ranging from 125 kHz to 13.56 kHz operating frequency. The printed circuit board may be a double sided board having the inductor on one side and memory and/or processor electronics on the other, in which case the diagnostic system would incorporate an RFID reader/writer. The printed circuit board can have a plurality of contact pads for physical contact with associated spring contacts of the diagnostic system, enabling the diagnostic system to read and write information directly from and to the circuit board on the cartridge.

A further contemplated type of identification means includes memory and/or processor electronics comprising electronic chip means in the form of an Electro-Erasable-Programmable-Read Only Memory (EEPROM) chip. The EEPROM can have four contacts: one for ground, another for positive voltage in and two for use in signalling. A number of independent pieces of information may be read from and programmed to the EEPROM in a serial addressed manner.

Alternatively, a two contact EEPROM may be used, with the reduced number of contacts reducing the risk of having a bad connection between the EEPROM and the diagnostics system. For a two contact arrangement, the EEPROM would have the ability to generate its own power by charging an internal capacitor from the positive voltage sing from the read write data sent the diagnostic system, thus eliminating the need for separate dedicated power contacts.

The identification means can be used in an active role, such that it includes a small central processor used in combination with a battery power source. The battery may be a separate component located on the disposable cartridge and the circuit board would then contain contacts to connect to the battery. Alternatively, the battery may be an integral part of a circuit board of the identification means. The connection to the diagnostic system may be either via a contact or wireless system.

According to a further embodiment, the identification means carried by a cartridge may be a read/write magnetic strip on which information is stored. Other means of storing data on a cartridge in an amendable form will be clear to those in the art.

In a contemplated method of operation, the diagnostic system reads the volume of reagent within the cartridge and then, as reagent is used, calculates the volume remaining and writes this information back to the identification means carried by the cartridge. The diagnostic system may write the change in volume to the identification means every time some of the reagent is used, or it may calculate the volume of reagent remaining and write this information to the identification means prior to the cartridge being removed from the system.

The diagnostic system advantageously reads the active shelf life of the reagent when the cartridge is first inserted into the system and, using the date of insertion and the active shelf life, calculates the expiration date of the active shelf life and writes this back to the cartridge identification means. Advantageously, the active shelf life expiration date of the reagent is utilized by the diagnostic system, such that the system will not dispense further reagent from a particular cartridge once the shelf life expiration date has passed. In this manner, a cartridge can be placed in the diagnostic system and, at some later time, removed in a partially full state. When the cartridge is later reinserted into the system, and if the relevant information has previously been written back to the cartridge, the system not only will be able to read the volume of reagent remaining in the cartridge and signal when the cartridge needs replacing, but also the system will know the active expiration date of the reagent and, if the date has passed during the period when the cartridge was previously removed from the system and the present time when it is reinserted, the system will not dispense reagent from the cartridge.

As previously mentioned, the identification means desirably has means for sensing and storing the temperature of the reagent in the cartridge, and if the reagent temperature rises above or falls below one or more predetermined temperatures, this will be sensed by the diagnostic system when the cartridge is located within the system and the system reads the identification means carried by the cartridge. The means for detecting the temperature may comprise a temperature sensor on a circuit board, and the circuit board may additionally include a pressure sensor or a humidity sensor. Preferably the temperature sensor comprises a dedicated circuit that may contain, by way of example, a thermal fuse. Alternatively, the temperature sensor may comprise an electronic temperature monitoring component such as a thermistor, and it may operate by way of selection of material composition within the identification means. For example, if a magnetic identification means is used, the material could lose a part of its magnetic coding at a certain temperature.

The circuit board monitors the signals from the sensor or sensors and, by tracking the signals, can determine if the cartridge has been stored or transported outside of predetermined storage conditions. This is particularly relevant in respect of reagents that have a critical storage temperature, for example between 4 and 8 degrees centigrade, where the outcome of tests may be wrong if the reagent has been stored outside of those temperatures. By means of the on-board battery, the conditions can be monitored even when the cartridge is not in situ on the diagnostic system. The electronics of the cartridge identification means advantageously include a dock that monitors the period of time for which the reagent is stored outside of its predetermined storage temperature range, which measured time period can be used in conjunction with the temperature to determine if the reagent can still be used. For example, if a reagent goes marginally outside its storage temperature for a short period of time it may not degrade, whereas if it is maintained marginally outside its temperature range for an extended period of time it may degrade sufficiently to give false diagnostic results.

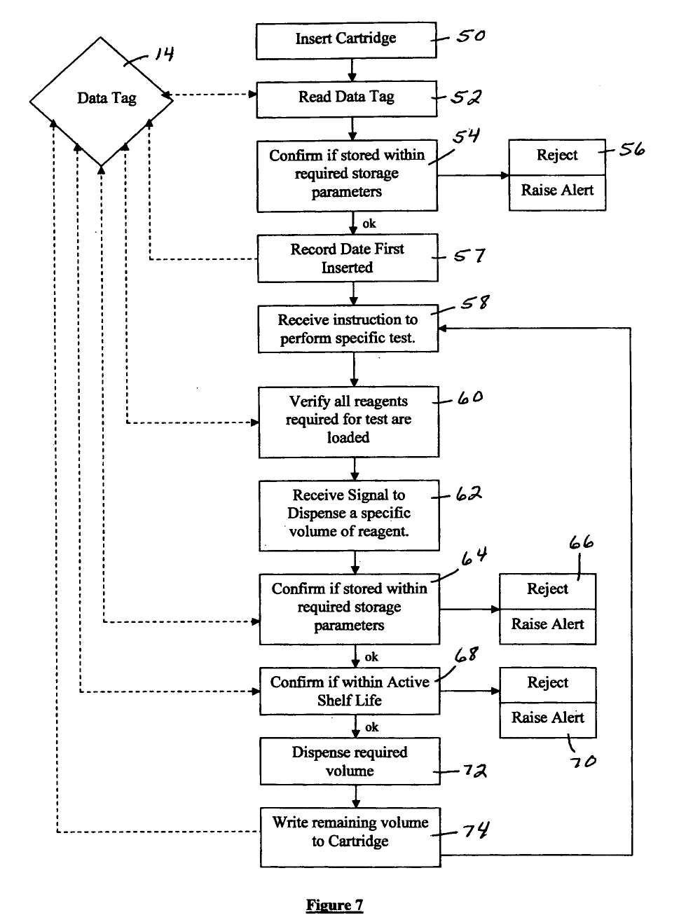

The flow chart of FIG. 7 shows one of a number of possible modes of operation of the diagnostic system, which begins at a box 50 with placement of at least one cartridge 1 in the carousel 40 of the in vitro diagnostic system. The cartridge carries an identification means or data tag 14, and at a box 52 the data tag is read by the reader 42 associated with the carousel position in which the cartridge is placed. The reader communicates the data to the control circuitry contained in the housing 38 and at a box 54 the control circuitry determines whether the reagent in the cartridge has been stored within required storage parameters. If the reagent has not been so stored, at a box 56 the cartridge is rejected and an alert signal is generated, but if it has been properly stored, then at a box 57 the date of first insertion of the cartridge into the diagnostic system is recorded by being written to the cartridge data tag 14. At this point a technician, at a box 58, inputs to the diagnostic system instructions to perform a specific diagnostic test on fluid contained in a vial 34, in response to which the diagnostic system, at a box 60, reads the data tags of the one or more cartridges carried by the carousel 40 to confirm that reagent(s) required to perform the specific test are positioned on the carousel and available. If all necessary reagents are available, then at a box 62 the control circuitry determines a specific cartridge, the reagent of which is to be dispensed and, at a box 64 confirms, by reading data on the cartridge data tag 14, that the reagent has been properly stored. If it has not been properly stored, at a box 66 the reagent is rejected and an alert signal is generated. If, however, the reagent has been properly stored, then at a box 68 it is determined, by use of the associated reader 42 to read data from the cartridge data tag 14, whether the reagent is within its active shelf life and, if it is not, at a box 70 the reagent is rejected and an alert is generated. On the other hand, if the reagent is within its active shelf life, then at a box 72 the control circuitry operates the diagnostic system to dispense from the cartridge a predetermined required volume of reagent into the fluid in the vial 34, following which at a box 74 the volume of reagent remaining in the cartridge is written to the cartridge data tag 14. If additional reagent is to be dispensed, then operation of the diagnostic returns to the box 58.

While embodiments of the invention have been described in detail, various modifications and other embodiments thereof may be devised by one skilled in the art without departing from the spirit and scope of the invention, as defined in the appended claims.

What is claimed is:

1. A method of controlling dispensing of a flowable reagent in an in vitro diagnostic system, comprising the steps of:
placing in the diagnostic system a cartridge having a reservoir of reagent, a temperature sensor for sensing the temperature of the reagent and an identifier that contains information pertinent to the reagent including the sensed temperature of the reagent;
reading with the diagnostic system the information contained in the identifier; and
using the information read by the diagnostic system to control the diagnostic system in dispensing reagent from the cartridge.

2. A method according to claim 1, wherein the cartridge has a disposable sanitary pump for dispensing reagent from the reservoir, and including the steps of:
driving the pump with the diagnostic system to dispense reagent; and
controlling the diagnostic system in performing said driving step in accordance with information contained in the identifier.

3. A method according to claim 1, wherein information contained in the identifier consists of one or more of: an identification of the reagent in the reservoir; the expiration date of the reagent; the active shelf life of the reagent; the volume of the reagent in the reservoir; an identification of the origin of the reagent; and the maximum storage temperature of the reagent.

4. A method according to claim 1, said placing step comprising placing a plurality of cartridges in the diagnostic system, the identifier of each cartridge containing information relating to the identity of the reagent in the reservoir of the cartridge, said reading step comprising reading with the diagnostic system the identity of the reagent in the reservoir of each cartridge, and said using step comprising using the identity of the reagent in the reservoir of each cartridge to control the diagnostic system in dispensing reagent from a selected one or more of the cartridges.

5. A method according to claim 1, wherein the cartridge identifier contains information concerning the expiration date of the reagent in the reservoir, and said using step includes the step of preventing the diagnostic system from dispensing reagent that has expired.

6. A method according to claim 1, wherein the cartridge identifier contains information concerning the active shelf life of the reagent in the reservoir, and said using step includes the step of preventing the diagnostic system from dispensing the reagent if the active shelf life of the reagent has expired.

7. A method according to claim 1, wherein the cartridge identifier contains information concerning the active shelf life of the reagent in the reservoir, and said using step controls the diagnostic system to generate a signal upon expiration of the active shelf life of the reagent.

8. A method according to claim 1, wherein the identifier of the cartridge is permanently associated with the cartridge and the information contained in it is for being read by the diagnostic system.

9. A method according to claim 8, wherein the cartridge identifier includes a radio frequency identification (RFID) tag and said reading step includes reading the RFID tag with a reader of the diagnostic system.

10. A method according to claim 9, wherein said placing step comprises placing a plurality of cartridges in the diagnostic system, and said reading step comprises providing the diagnostic system with an RFID tag reader at each position where a cartridge is placed for reading only the information contained in the identifier of the cartridge placed in that position.

11. A method according to claim 10, wherein each diagnostic system RFID reader includes a short range reader circuit.

12. A method according to claim 11, wherein the short range reader circuit of each diagnostic system RFID reader has a limited operating range, such that the RFID reader cannot read the information contained in the REID tag of a cartridge until the cartridge is substantially inserted into the diagnostic system.

13. A method according to claim 12, wherein the short range reader circuit of each diagnostic system RFID reader has a single operating frequency.

14. A method according to claim 13, wherein the single frequency of the short range reader circuit of each diagnostic system RFID reader is above 13 MHz.

15. A method according to claim 8, wherein said reading step includes providing the diagnostic system with an identifier reader/writer so that the diagnostic system can read information from the cartridge identifier, write information to the identifier and overwrite information contained by the identifier.

16. A method according to claim 15, wherein the cartridge identifier is a universal data tag comprising at least one of memory circuitry and processor circuitry and is attached to the cartridge.

17. A method according to claim 16, wherein the universal data tag consists of a printed circuit board on which the at least one of memory circuitry and processor circuitry is provided, and including the step of providing the printed circuit board with a transceiver for communicating with the diagnostic system reader/writer.

18. A method according to claim 17, including the step of providing the printed circuit board with a printed 1000 μH inductor for inductive non-contact communication between the at least one of memory circuitry and processor circuitry and the diagnostic system reader/writer, thereby enabling the use of radio frequency identification (RFID) type devices ranging from 125 kHz to 13.56 kHz operating frequency.

19. A method according to claim 18, wherein the printed circuit board is a double sided board having the inductor mounted on one side and the at least one of memory circuitry and processor circuitry mounted on the other side.

20. A method according to claim 17, including the steps of providing the printed circuit board with a plurality of contact pads and the diagnostic system with physical spring contacts, and establishing contact between the contact pads and spring contacts to enable the diagnostic system to read and write information from and to the cartridge universal data tag.

21. A method according to claim 16, wherein the at least one of memory circuitry and processor circuitry comprises an Electro-Erasable-Programmable-Read Only Memory (EEPROM) chip.

22. A method according to claim 21, including the step of providing the EEPROM chip with four contacts comprising a ground contact, a positive voltage in contact and two signal contacts.

23. A method according to claim 22, including the step of reading information from and programming information to the EEPROM in a serial addressed manner.

24. A method according to claim 21, including the steps of providing a power supply for the EEPROM by charging an internal capacitor of the EEPROM from a positive voltage sing from data sent to the EEPROM by the diagnostic system.

25. A method according to claim 16, including the step of using the universal identification tag in an active role by providing it with a central processor and a battery power source.

26. A method according to claim 25, wherein said step of providing a battery power source provides the battery power source as a separate component located on the cartridge, and including the step of providing the circuit board with contacts to connect to the battery.

27. A method according to claim 8, wherein the identifier stores information in magnetic form.

28. A method according to claim 8, wherein the identifier stores information on a read/write magnetic strip.

29. A method according to claim 1, wherein the identifier contains information relating to the volume of reagent in the cartridge reservoir, said reading step including reading with the diagnostic system the volume of reagent in the reservoir upon the cartridge being placed in the diagnostic system and then, as the reagent is used, performing with the diagnostic system the additional steps of calculating the volume of reagent remaining in the cartridge reservoir, and writing to the cartridge identifier information relating to the volume of reagent remaining.

30. A method according to claim 29, wherein said step of writing information to the cartridge identifier relating to the volume of reagent remaining in the cartridge reservoir is performed every time reagent is used from the reservoir.

31. A method according to claim 29, wherein said step of writing information to the cartridge identifier relating to the volume of reagent remaining in the cartridge reservoir is performed prior to the cartridge being removed from the diagnostic system.

33. A method according to claims 15, wherein the cartridge identifier includes information relating to the active shelf life of the reagent in the cartridge reservoir, and said reading step comprises reading with the diagnostic system the active shelf life of the reagent when the cartridge is first inserted into the diagnostic system, and including the steps, performed by the diagnostic system, of using the date of insertion of the cartridge into the diagnostic system to calculate the expiration date of the active shelf life of the reagent, and writing the active shelf life expiration date of the reagent to the cartridge identifier.

34. A method according to claim 33, including the step of inhibiting the diagnostic system from dispensing further reagent from a cartridge once the active shelf life expiration date of the reagent has passed.

35. A method according to claim 8, wherein the information contained by the cartridge identifier is stored on a bar code.

36. A method according to claim 1, including the steps of detecting the temperature of the reagent in the cartridge, and recording in the cartridge identifier an occurrence of the reagent temperature changing past at least one predetermined temperature, said reading step reading from the cartridge identifier the occurrence of the reagent temperature changing past the at least one predetermined temperature when the cartridge is place in the diagnostic system.

37. A method according to claim 36, wherein said detecting and recording steps are performed by providing the cartridge with a dedicated circuit containing a thermal fuse associated with the identifier.

38. A method according to claim 36, wherein said detecting and recording steps are performed by providing the cartridge with an electronic temperature monitor associated with the identifier.

39. A method according to claims 36, including the step of measuring the time for which the temperature of the reagent remains changed past the at least one predetermined temperature.

40. A method according to claim 36, wherein the cartridge identifier is a magnetic device that loses a portion of its magnetic coding while the temperature of the reagent remains changed past the at least one predetermined temperature.

41. A cartridge for containing reagent for use in an in vitro diagnostic system, said cartridge comprising:
a reservoir for holding reagent;
means for sensing the temperature of the reagent;
means for dispensing reagent from said reservoir;
and data means containing information pertinent to reagent contained in said reservoir, including the sensed temperature of the reagent.

42. A cartridge as in claim 41, said temperature sensing means sensing the storage temperature of the reagent and providing the storage temperature to said data means.

43. A cartridge as in claim 41, wherein said means for dispensing reagent from said cartridge includes a disposable sanitary pump.

44. A cartridge as in claim 41, said data means containing information pertinent to one or more of: an identification of the reagent in said reservoir; the expiration date of the reagent; the active shelf life of the reagent; the volume of reagent in said reservoir; the origin of the reagent; and the maximum storage temperature of the reagent.

45. A cartridge as in claim 41, wherein said data means comprises a radio frequency identification (RFID) tag.

46. A cartridge as in claim 41, wherein said data means is for having information both read from and written to said data means.

47. A cartridge as in claim 41, wherein said data means comprises a printed circuit board having at least one of memory circuitry and processor circuitry, said data means also having a transceiver for use in reading information from and writing information to said at least one of said memory circuitry and said processor circuitry.

48. A cartridge as in claim 47, wherein said cartridge further includes electrical contact means electrically coupled to said data means for reading data from and writing data to said data means.

49. A cartridge as in claim 47, wherein said at least one of said memory circuitry and said processor circuitry comprises an Electro-Erasable-Programmable-Read Only Memory (EEPROM) chip.

50. A cartridge as in claim 49, said cartridge further including a power supply for said EEPROM comprising a capacitor charged by a positive voltage sing from data sent to said EEPROM.

51. A cartridge as in claim 47, further including battery means for powering said data means.

52. A cartridge as in claim 41, wherein said data means comprises a read/write magnetic strip.

53. A cartridge as in claim 41, wherein said data means comprises read/write data means.

54. An in vitro diagnostic system that uses a flowable reagent in the performance of diagnostic testing, said system comprising:
a cartridge including a reservoir for holding reagent, means for dispensing reagent from said reservoir, means for sensing the temperature of reagent in said reservoir, and data means containing information pertinent to reagent in said reservoir, including the sensed temperature of the reagent; and
an apparatus for receiving said cartridge and for using reagent in said cartridge reservoir to diagnostically test a fluid, said apparatus including reader means for reading information contained by said cartridge data means, means for operating said cartridge dispensing means to dispense reagent from said cartridge reservoir, and control circuit means for controlling said operating means to dispense reagent from said cartridge reservoir in accordance with information read by said reader means from said cartridge data means.

55. A system according to claim 54, wherein the cartridge dispensing means includes a disposable sanitary pump for dispensing reagent from said reservoir, said apparatus operating means operating said pump under control of said control circuit means to dispense reagent in accordance with information read by said reader means from said cartridge data means.

56. A system according to claim 54, wherein information contained in said cartridge data means consists of one or more of: an identification of reagent in said reservoir; the expiration date of the reagent; the active shelf life of the reagent; the volume of the reagent in said reservoir; an identification of the origin of the reagent; and the maximum storage temperature of the reagent.

57. A system according to claim 56, wherein said apparatus control circuit means prevents operation of said operating means to dispense reagent from said cartridge reservoir in response to said reader means reading from said cartridge data means an expiration date of the reagent that has passed.

58. A system according to claim 56, wherein said apparatus control circuit means prevents operation of said operating means to dispense reagent from said cartridge reservoir in response to said reader means reading from said cartridge data means an active shelf life of the reagent that has passed.

59. A system according to claim 54, wherein said cartridge data means includes a radio frequency identification (RFID) tag and said apparatus reader means reads information contained by said RFID tag.

60. A system according to claim 54, wherein said cartridge data means is a read/write data means and said apparatus reader means is a read/write means for both reading information from and writing information to said cartridge read/write data means.

61. A system according to claim 60, wherein said cartridge data means comprises at least one of memory circuitry and processor circuitry.

62. A system according to claim 61, wherein said cartridge data means comprises a printed circuit board having said at least one of said memory circuitry and said processor circuitry and including a transceiver, and said apparatus reader means including read/write means for reading information from and writing information to said at least one of said memory circuitry and said processor circuitry via said transceiver.

63. A system according to claim 62, wherein said at least one of said memory circuitry and said processor circuitry comprises an Electro-Erasable-Programmable-Read Only Memory (EEPROM) chip.

64. A system according to claim 63, including a power supply for said EEPROM chip comprising a capacitor charged by a positive voltage sing from data sent to the EEPROM by said apparatus read/write means.

65. A system according to claim 54, said cartridge data means including central processor means and battery means.

66. A system according to claim 54, said cartridge data means including magnetic data storage means.

67. A system according to claim 66, wherein said magnetic data storage means comprises a read/write magnetic strip.

68. A system according to claim 54, wherein said cartridge data means includes a bar code.

69. A system according to claim 54, wherein said cartridge temperature sensing means comprises a thermal fuse.

70. A system according to claim 54, wherein said cartridge temperature sensing means comprises an electronic temperature monitor.

71. A system according to claim 54, wherein said cartridge temperature sensing means comprises magnetic temperature sensing means that loses a portion of its magnetic coding while the temperature of the reagent remains changed past at least one predetermined temperature.
